(19) United States
(12) Patent Application Publication
(10) Pub. No.: US 2025/0297937 A1
(43) Pub. Date: Sep. 25, 2025

(54) HEMATOLOGY ANALYZER

(71) Applicant: L&T TECHNOLOGY SERVICES LIMITED, Chennai (IN)

(72) Inventors: UMESH RAMAIAH, Bangalore (IN); SHRISHAIL BADNAL, Dharwad (IN); BEDAREDDIHALLI CHANDRASHEKHAR UMASHANKARA, Mysore (IN); SHAMAL ALAKKAD, Kannur (IN); NITHISH BHARGAV, Mysuru (IN)

(21) Appl. No.: 18/811,917

(22) Filed: Aug. 22, 2024

(30) Foreign Application Priority Data
Mar. 22, 2024 (IN) 202441023285

(51) Int. Cl. G01N 15/10

(52) U.S. Cl. CPC G01N 15/10

(57) ABSTRACT

A hematology analyzer for analyzing a fluid sample and comprising a frame body defining a first axis (X-X′) and a second axis (Y-Y′), a cartridge unit having a first compartment containing the fluid sample and a second compartment containing a cleaning fluid, a fluid analysis module comprising a first probe and a second probe, a first transmission unit configured to hold and move the cartridge unit along the first axis (X-X′) to align the first compartment and the second compartment with the first probe and the second probe, respectively, and a second transmission unit configured to move the fluid analysis module along the second axis (Y-Y′) such that the first probe and the second probe pierce the first compartment and the second compartment, respectively.

### TECHNICAL FIELD

The present disclosure relates to the field of medical devices. Particularly, the present disclosure relates to a hematology analyzer and a method for analyzing a fluid sample.

### BACKGROUND

The information in this section merely provides background information related to the present disclosure and may not constitute prior art(s) for the present disclosure.

Clinical instruments currently in use for analyzing the components of a blood sample employ a wide variety of electrically and optically based equipment and techniques to identify and quantify platelets from other cells or particles, such as red blood cells, including normal red blood cells and microcytic red blood cells, red blood cell fragments, oversized platelets and platelet aggregates.

Few known devices and method utilizing monoclonal antibodies which bind specifically to platelet cells are widely recognized. Preparation of the sample for said devices and methods requires multiple dilutions and incubation periods. Other known devices and methods to provide platelet enumeration include treating the sample with a fluorescent dye and identifying the platelet cell by a fluorescence measurement.

However, the known devices and methods for analyzing the blood samples suffer from various limitations, for example, long incubation periods for instruments with high sample throughput requirements, complexity of addition and cost associated with antibodies, large number of electrical/electronic modules and sensors required in the device and thus heavy cost of hardware in the devices to perform various operations. In brief, the known devices come with a separate reagent/antibodies fluid section, resulting in a complex fluidic design due to multiple modules and heavy costs of the devices.

Accordingly, there remains a need in the domain for improved hematology analyzer and method for analyzing a fluid sample and that address at least the limitations described above.

### SUMMARY OF THE INVENTION

The one or more shortcomings of the prior art are overcome by the system as claimed, and additional advantages are provided through the provision of the system and method as claimed in the present disclosure. Additional features and advantages are realized through the techniques of the present disclosure. Other embodiments and aspects of the disclosure are described in detail herein and are considered a part of the claimed disclosure.

Pursuant to the embodiments of the present disclosure, in an aspect, a hematology analyzer for analyzing a fluid sample is disclosed. The hematology analyzer comprises a frame body having a platform and a pair of rails arranged above the platform and supported by one or more columns. The frame body defines a first axis along the pair of rails and a second axis that is perpendicular to the first axis and the platform. The hematology analyzer further comprises a cartridge unit comprising at least two compartments, in which a first compartment of the at least two compartments contains the fluid sample to the analyzed and a second compartment of the at least two compartments contains a cleaning fluid. The hematology analyzer further comprises a first transmission unit provided on the pair of rails and configured to hold the cartridge unit, and move the cartridge unit along the first axis of the frame body. The hematology analyzer furthermore comprises a second transmission unit provided on the platform, and a fluid analysis module disposed on the second transmission unit. The fluid analysis module is adapted to move along the second axis of the frame body by the second transmission unit and comprises a first probe and a second probe. Further, the first transmission unit is configured to move the cartridge unit along the first axis of the frame body to align the first compartment and the second compartment with the first probe and the second probe, respectively. Furthermore, the second transmission unit is configured to move the fluid analysis module along the second axis of the frame body such that the first probe pierces the first compartment and the second probe pierces the second compartment.

In another non-limiting embodiment of the present disclosure, the cartridge unit comprises four compartments, in which the first compartment contains a red blood cells sample to be analyzed, the second compartment contains the cleaning fluid, a third compartment contains a white blood cells sample to be analyzed, and a fourth compartment contains the cleaning fluid.

In another non-limiting embodiment of the present disclosure, each compartment of the at least two compartments comprises an elastomeric seal which is adapted to be pierced by the respective probe of the fluid analysis module.

In another non-limiting embodiment of the present disclosure, each of the red blood cells sample and the white blood cells sample is prepared by mixing the fluid sample with one or more reagents. The one or more reagents mixed with the fluid sample to form the red blood cells sample comprises hematology diluent. The one or more reagents mixed with the fluid sample to form the white blood cells sample comprises LYSE.

In another non-limiting embodiment of the present disclosure, the cleaning fluid cleans the first probe of the fluid analysis module and comprises RINSE.

In another non-limiting embodiment of the present disclosure, the red blood cells sample and the white blood cells sample are prepared in the cartridge unit outside the hematology analyzer. The cartridge unit is a disposable cartridge unit.

In another non-limiting embodiment of the present disclosure, the fluid analysis module is configured to count red blood cells (RBCs), white blood cells (WBCs), hemoglobin, and platelet counts.

In another non-limiting embodiment of the present disclosure, the second probe comprises a three-way valve adapted to supply the cleaning fluid to the first probe to clean the first probe internally and externally.

In another non-limiting embodiment of the present disclosure, the first transmission unit comprises a first actuator, a drive shaft and a driven shaft adapted to be driven by the first actuator, a first roller and a second roller disposed opposite to the drive shaft and the driven shaft, respectively; and a first conveyer belt extending between the drive shaft and the first roller and a second conveyer belt extending between the driven shaft and the second roller. Each of the first conveyer belt and the second conveyer belt is adapted to be driven by the first actuator such that the cartridge unit held by the first transmission unit is movable along with the first axis of the frame body.

In another non-limiting embodiment of the present disclosure, each of the first conveyer belt and the second conveyer belt comprises a plurality of segments for holding the cartridge unit.

In another non-limiting embodiment of the present disclosure, the second transmission unit comprises a second actuator, and a lead screw coupled to an output shaft of the second actuator and adapted to be rotated with the output shaft of the second actuator. The fluid analysis module is disposed on the lead screw and is moved along with the second axis of the frame body, upon a rotation of the lead screw.

Pursuant to the other embodiments of the present disclosure, in an aspect, a method for analyzing a fluid sample is disclosed. The method comprises preparing the fluid sample in a first compartment of a cartridge unit; The method further comprises placing the cartridge unit in a first transmission unit of a hematology analyzer, in which a pair of conveyer belts of the first transmission unit is adapted to hold and move the cartridge unit along a first axis of the hematology analyzer. The method further comprises moving the cartridge unit, by the first transmission unit, along the first axis such that the first compartment of the cartridge unit aligns with a first probe of a fluid analysis module of the hematology analyzer. The method furthermore comprises moving the fluid analysis module along a second axis of the hematology analyzer such that the first probe pierces the first compartment of the cartridge unit for receiving and analyzing the fluid sample, the second axis being perpendicular to the first axis.

In another non-limiting embodiment of the present disclosure, preparing the fluid sample in the first compartment of the cartridge unit comprises mixing the fluid sample with one or more reagents. The one or more reagents comprises hematology diluent or LYSE. Further, mixing the fluid sample with the one or more reagents is performed outside the hematology analyzer.

In another non-limiting embodiment of the present disclosure, the method comprises placing a cleaning fluid in a second compartment of the cartridge unit. The method further comprises moving the cartridge unit, by the first transmission unit, along the first axis such that the second compartment aligns with a second probe of the fluid analysis module while the first compartment is aligned with the first probe. The method furthermore comprises moving the fluid analysis module along the second axis of the hematology analyzer such that the second probe pierces the second compartment for receiving the cleaning fluid to clean the first probe of the fluid analysis module.

Within the scope of the present disclosure, the hematology analyzer and the method for analyzing the fluid sample require a single-usage cartridge for complete blood count (CBC) analyzer device. The design of the hematology analyzer of the present disclosure enhances analyzer device compactness and case of handling, requires a minimal number of modules, and reduces the cost for each test performed.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The novel features and characteristics of the disclosure are set forth in the present description. The present disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 is a perspective view of an exemplary hematology analyzer, in accordance with an embodiment of the present disclosure;

FIG. 2 is a perspective view of internal components of the hematology analyzer of FIG. 1, in accordance with an embodiment of the present disclosure;

FIG. 3 is a front perspective view of the internal components of the hematology analyzer of FIG. 1, in which a fluid analysis module engages with first and second compartments of a cartridge unit of the hematology analyzer, in accordance with an embodiment of the present disclosure;

FIG. 4 is a front perspective view of the internal components of the hematology analyzer of FIG. 1, in which the fluid analysis module engages with third and fourth compartments of the cartridge unit of the hematology analyzer, in accordance with an embodiment of the present disclosure;

FIG. 5 is a front view of the cartridge unit of FIGS. 3 and 4, in accordance with an embodiment of the present disclosure; and

FIG. 6 is a flow chart depicting a method for analyzing a fluid sample, in accordance with an embodiment of the present disclosure.

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present disclosure.

### DETAILED DESCRIPTION

While the disclosure is susceptible to various modifications and alternative forms, specific embodiments thereof have been shown by way of example in the FIGS. and will be described in detail below. It should be understood, however that it is not intended to limit the present disclosure to the particular forms disclosed, but on the contrary, the disclosure is to cover all modifications, equivalents, and alternatives falling within the scope of the present disclosure as defined by the appended claims.

Before describing detailed embodiments, it may be observed that the novelty and inventive step that are in accordance with the present disclosure resides in a hematology analyzer and a method for analyzing a fluid sample. It is to be noted that a person skilled in the art can be motivated from the present disclosure and modify the various constructions of the hematology analyzer and the method. However, such modification should be construed within the scope of the present disclosure. Accordingly, the drawings are showing only those specific details that are pertinent to understanding the embodiments of the present disclosure so as not to obscure the disclosure with details that will be readily apparent to those of ordinary skill in the art having benefit of the description herein.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusions, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

The terms like “at least one” and “one or more” may be used interchangeably or in combination throughout the description.

Pursuant to the embodiments of the present disclosure, in an aspect, a hematology analyzer for analyzing a fluid sample is disclosed. The hematology analyzer comprises a frame body having a platform and a pair of rails arranged above the platform and supported by one or more columns. The frame body defines a first axis along the pair of rails and a second axis that is perpendicular to the first axis and the platform. The hematology analyzer further comprises a cartridge unit comprising at least two compartments, in which a first compartment of the at least two compartments contains the fluid sample to the analyzed and a second compartment of the at least two compartments contains a cleaning fluid. The hematology analyzer further comprises a first transmission unit provided on the pair of rails and configured to hold the cartridge unit, and move the cartridge unit along the first axis of the frame body. The hematology analyzer furthermore comprises a second transmission unit provided on the platform, and a fluid analysis module disposed on the second transmission unit. The fluid analysis module is adapted to move along the second axis of the frame body by the second transmission unit and comprises a first probe and a second probe. Further, the first transmission unit is configured to move the cartridge unit along the first axis of the frame body to align the first compartment and the second compartment with the first probe and the second probe, respectively. Furthermore, the second transmission unit is configured to move the fluid analysis module along the second axis of the frame body such that the first probe pierces the first compartment and the second probe pierces the second compartment. In an embodiment, the cartridge unit comprises four compartments, in which the first compartment contains a red blood cells sample to be analyzed, the second compartment contains the cleaning fluid, a third compartment contains a white blood cells sample to be analyzed, and a fourth compartment contains the cleaning fluid. Each compartment of the at least two compartments comprises an elastomeric seal which is adapted to be pierced by the respective probe of the fluid analysis module. Further, each of the red blood cells sample and the white blood cells sample is prepared by mixing the fluid sample with one or more reagents. The one or more reagents mixed with the fluid sample to form the red blood cells sample comprises hematology diluent. The one or more reagents mixed with the fluid sample to form the white blood cells sample comprises LYSE. Further, the cleaning fluid cleans the first probe of the fluid analysis module and comprises RINSE. In an embodiment, the second probe comprises a three-way valve adapted to supply the cleaning fluid to the first probe to clean the first probe internally and externally.

The red blood cells sample and the white blood cells sample are prepared in the cartridge unit outside the hematology analyzer. The cartridge unit is a disposable cartridge unit. The fluid analysis module is configured to count red blood cells (RBCs), white blood cells (WBCs), hemoglobin, and platelet counts.

In an embodiment, the first transmission unit comprises a first actuator, a drive shaft and a driven shaft adapted to be driven by the first actuator, a first roller and a second roller disposed opposite to the drive shaft and the driven shaft, respectively; and a first conveyer belt extending between the drive shaft and the first roller and a second conveyer belt extending between the driven shaft and the second roller. Each of the first conveyer belt and the second conveyer belt is adapted to be driven by the first actuator such that the cartridge unit held by the first transmission unit is movable along with the first axis of the frame body. Each of the first conveyer belt and the second conveyer belt comprises a plurality of segments for holding the cartridge unit.

In an embodiment, the second transmission unit comprises a second actuator, and a lead screw coupled to an output shaft of the second actuator and adapted to be rotated with the output shaft of the second actuator. The fluid analysis module is disposed on the lead screw and is moved along with the second axis of the frame body, upon a rotation of the lead screw.

Pursuant to the other embodiments of the present disclosure, in an aspect, a method for analyzing a fluid sample is disclosed. The method comprises preparing the fluid sample in a first compartment of a cartridge unit; The method further comprises placing the cartridge unit in a first transmission unit of a hematology analyzer, in which a pair of conveyer belts of the first transmission unit is adapted to hold and move the cartridge unit along a first axis of the hematology analyzer. The method further comprises moving the cartridge unit, by the first transmission unit, along the first axis such that the first compartment of the cartridge unit aligns with a first probe of a fluid analysis module of the hematology analyzer. The method furthermore comprises moving the fluid analysis module along a second axis of the hematology analyzer such that the first probe pierces the first compartment of the cartridge unit for receiving and analyzing the fluid sample, the second axis being perpendicular to the first axis. According to the method, preparing the fluid sample in the first compartment of the cartridge unit comprises mixing the fluid sample with one or more reagents. The one or more reagents comprises hematology diluent or LYSE. Further, mixing the fluid sample with the one or more reagents is performed outside the hematology analyzer. Additionally, the method comprises placing a cleaning fluid in a second compartment of the cartridge unit. The method further comprises moving the cartridge unit, by the first transmission unit, along the first axis such that the second compartment aligns with a second probe of the fluid analysis module while the first compartment is aligned with the first probe. The method furthermore comprises moving the fluid analysis module along the second axis of the hematology analyzer such that the second probe pierces the second compartment for receiving the cleaning fluid to clean the first probe of the fluid analysis module.

It is to be understood that the aspects and embodiments of the present disclosure described above may be used in any combination with each other. Several of the aspects and embodiments may be combined together to form a further embodiment of the present disclosure.

Reference will now be made to the exemplary embodiments of the present disclosure, as illustrated in the accompanying drawings. Wherever possible same numerals will be used to refer to the same or like parts.

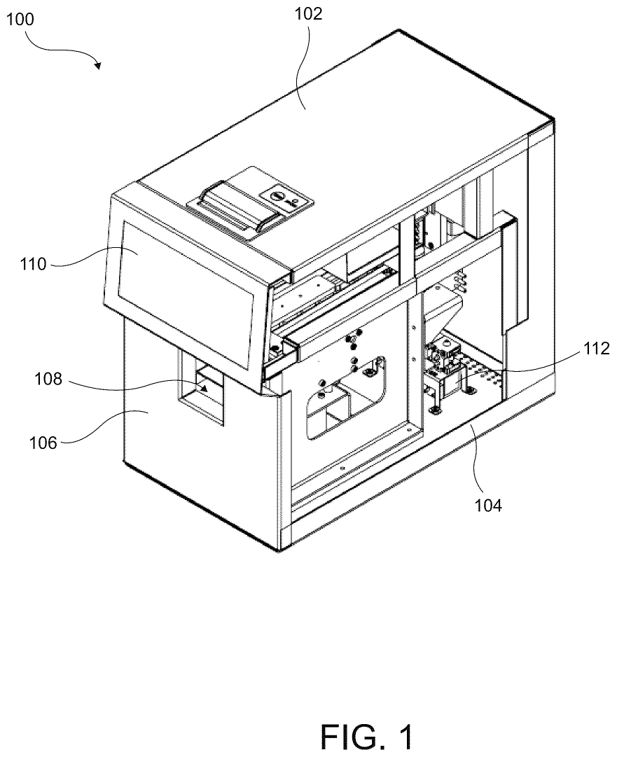

Embodiments of the present disclosure are described in the following paragraphs with reference to FIGS. 1 to 6. In FIGS. 1 to 6, the same element or elements which have same functions are indicated by the same reference signs.

FIG. 1 is a perspective view of an exemplary hematology analyzer (100) of the present disclosure. Without limiting the scope of protection of the present disclosure, the hematology analyzer (100) may be utilized to rapidly and autonomously count living cells in a fluid sample, for example, a blood sample. Typically, the hematology analyzer (100) is employed in the life sciences field to quantify cells for various purposes, for example, counting the platelets, red blood cells, white blood cells, etc. in the blood sample, and employing diverse methods to sort and count cells with similar characteristics. The primary function of the hematology analyzers (100) includes calculating cell concentrations to adjust molecular biology experiment reagents, assessing the growth rate of microorganisms, and determining the ratio of dead to live cells to evaluate cell viability. The principle underlying cell counting is the Coulter count principle, where hematology analyzers (100) utilize the instantaneous change in electrical resistance of blood cells passing through micropores to generate a pulse current for counting.

As shown in FIG. 1, the hematology analyzer (100) may comprise a frame body (102) that has a platform (104) on which one or more components of the hematology analyzer (100) are placed and arranged with each other. The hematology analyzer (100) may further comprise panels (106), for example, side panels and a top panel/enclosure, to cover and/or enclose the one or more components of the hematology analyzer (100). In an embodiment, the hematology analyzer (100) may comprise a window (108) through which a cartridge containing the fluid sample to be analyzed may be introduced into the hematology analyzer (100), a processing unit (not shown) that processes and computes the sample reports and a display unit (110) that is adapted to display the sample reports of the fluid sample. According to an embodiment of the present disclosure, the hematology analyzer (100) may comprise an electronic power supply system (112) that is associated with the processing unit and that makes use of a switching regulator to effectively transfer electrical power to the one or more components of the hematology analyzer (100).

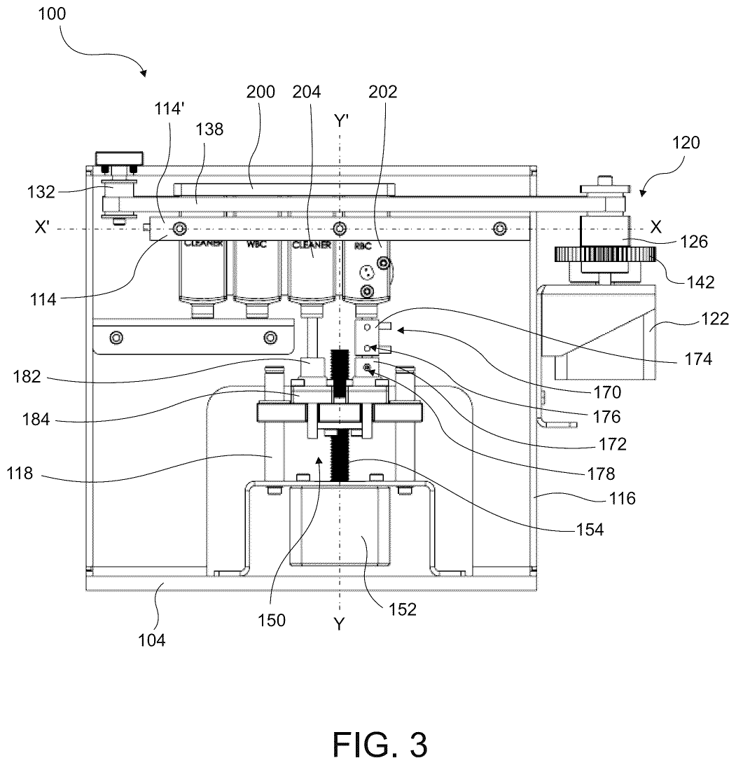

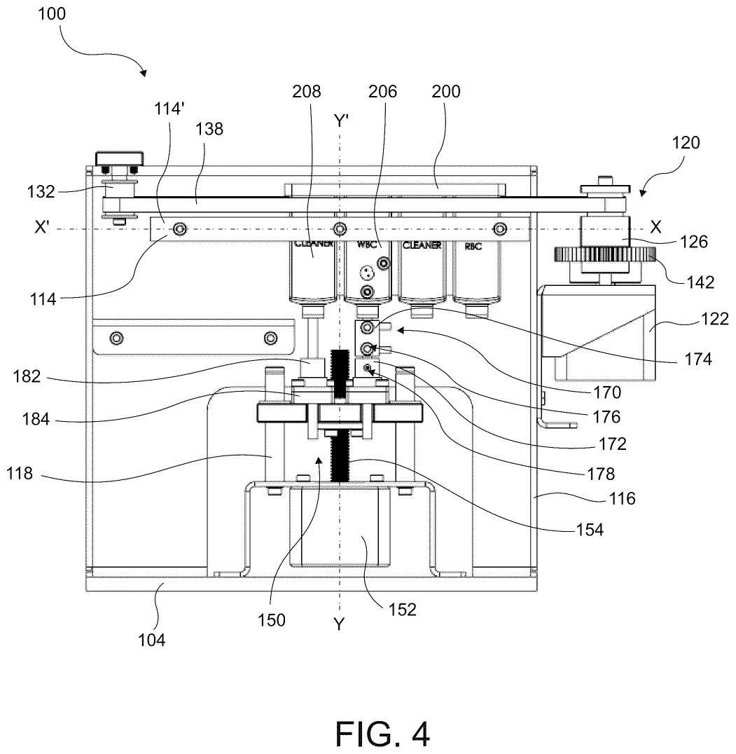

Further, with reference to FIGS. 3 and 4, the frame body (102) of the hematology analyzer (100) may comprise a pair of rails (114) arranged above the platform (104) and supported by one or more columns (116). The one or more columns (116) are mounted vertically on the platform (104) of the frame body (102). In accordance with the present disclosure, the frame body (102) comprises a first rail (114′) and a second rail (not visible) arranged above the platform (104) and supported by the one or more columns (116). The frame body (102) further defines a first axis (X-X′) that extends along the pair of rails (114). In an embodiment, the first axis (X-X′) extends parallel to each of the first rail (114′) and the second rail. The frame body (102) furthermore defines a second axis (Y-Y′) that is perpendicular to the first axis (X-X′) and the platform (104). In an embodiment, the second axis (Y-Y′) is the vertical axis of the frame body (102) of the hematology analyzer (100).

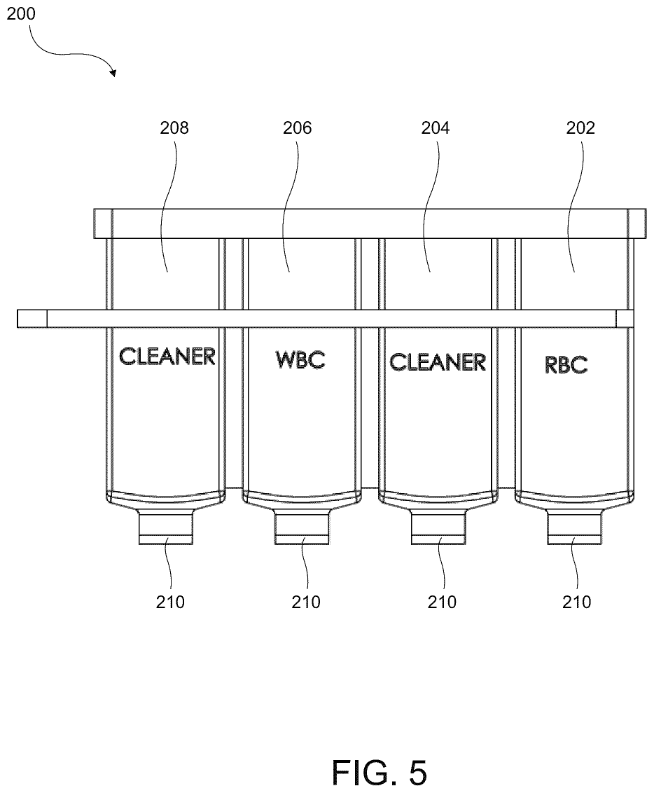

Further, the hematology analyzer (102) comprises a cartridge unit (200) that is adapted to contain the fluid sample to be analyzed and that is adapted to be positioned into the hematology analyzer (100), via the window (108) defined in the panel (106) of the hematology analyzer (100). As shown in FIG. 5, the cartridge unit (200) of the present disclosure comprises at least two compartments, for example a first compartment (202) and a second compartment (204). Without limiting the scope of protection of the present disclosure, the first compartment (202) is adapted to contain the fluid sample to the analyzed and the second compartment (204) is adapted to contain a cleaning fluid. Referring to FIG. 5, in accordance with the present disclosure, the cartridge unit (200) comprises four compartments, namely the first compartment (202), the second compartment (204), a third compartment (206) and a fourth compartment (208). In an embodiment, the first compartment (202) is adapted to contain a red blood cells sample to be analyzed. The second compartment (204) is adapted to contain the cleaning fluid. The third compartment (206) is adapted to contain a white blood cells sample to be analyzed. Further, the fourth compartment (208) is adapted to contain the cleaning fluid. In an embodiment of the present disclosure, each of the first compartment (202), the second compartment (204), the third compartment (206) and the fourth compartment (208) comprises an elastomeric seal (210) that is pierceable by a piercing element, for example a needle or a probe to draw the fluid, for example, the fluid sample or the cleaning fluid, contained in the compartment (202, 204, 206, 208).

In an embodiment of the present disclosure, the red blood cells sample contained in the first compartment (202) of the cartridge unit (200) is prepared by mixing the fluid sample, i.e., the blood sample with one or more reagents. The one or more reagents mixed with the blood sample to form the red blood cells sample may comprise, but not limited to, hematology diluent. Similarly, in an embodiment of the present disclosure, the white blood cells sample contained in the third compartment (206) of the cartridge unit (200) is prepared by mixing the fluid sample, i.e., the blood sample with one or more reagents. The one or more reagents mixed with the blood sample to form the white blood cells sample may comprise, but not limited to, LYSE. In accordance with the present disclosure, the red blood cells sample and the white blood cells sample are prepared in the cartridge unit (200) outside the hematology analyzer (100). Once the fluid analysis of the red blood cells sample and the white blood cells sample contained in the cartridge unit (200) is complete, the entire cartridge unit (200) is taken out from the hematology analyzer (100) and then discarded. In other words, according to the present disclosure, the cartridge unit (200) of the present disclosure is a single-usc and disposable cartridge unit (200).

In an embodiment of the present disclosure, the cartridge unit (200) is made of polycarbonate material and is transparent such that the fluids contained in the compartments (202, 204, 206, 208) of the cartridge unit (200) are visible from outside, for example, for visual inspection.

Further, without limiting the scope of protection of the present disclosure, the cleaning fluid contained in the second compartment (204) and the fourth compartment (208) of the cartridge unit may comprise, but not limited to, RINSE.

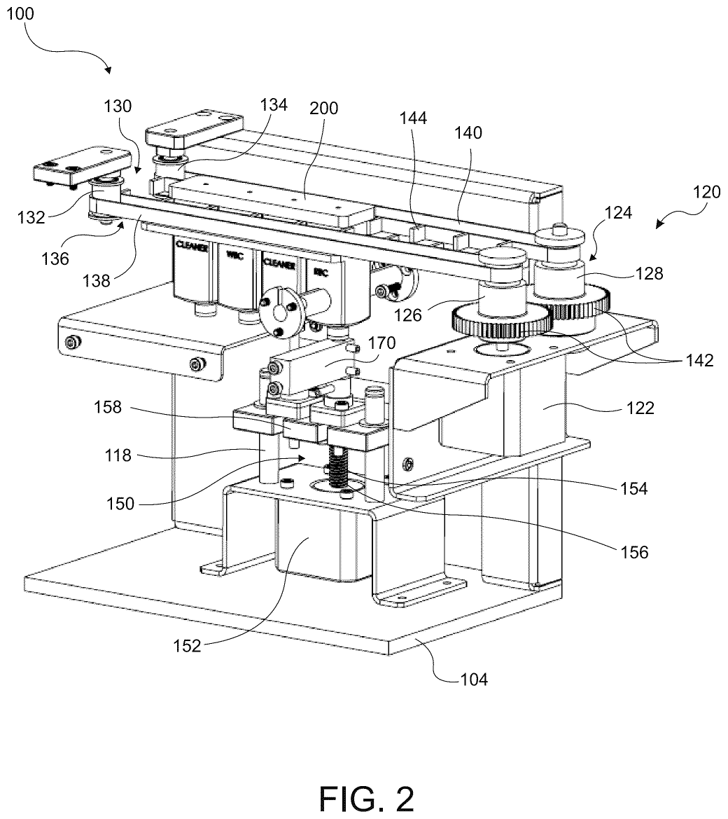

Referring to FIGS. 2, 3 and 4, the hematology analyzer (100) comprises a first transmission unit (120). According to the present disclosure, the first transmission unit (120) may be provided on the pair of rails (114). The first transmission unit (120) may be configured to hold the cartridge unit (200). The first transmission unit (120) may further be configured to move the cartridge unit (200) along the first axis (X-X′) of the frame body (102) of the hematology analyzer (100).

Still referring to FIGS. 2 to 4, first transmission unit (120) comprises a first actuator (122), a pair of shafts (124) adapted to be driven by the first actuator (122), a pair of rollers (130) operatively coupled to the pair of shafts (124) and a pair of conveyor belts (136). In an embodiment of the present disclosure, the first actuator (122) of the first transmission unit (120) is operatively coupled to the electronic power supply system (112) provided on the hematology analyzer (100) in order to draw energy for operations thereof. In a non-limiting embodiment of the present disclosure, the first actuator (122) is a stepper motor (122). The first actuator (122) is adapted to operate the one or more components of the first transmission unit (120).

As shown in FIGS. 2 to 4, the pair of shafts (124) of the first transmission unit (120) comprises a drive shaft (126) and a driven shaft (128) that are adapted to be driven by the first actuator (122). In accordance with the present disclosure, an output end of the first actuator (122) or the stepper motor (122) is coupled to the drive shaft (126) such that the drive shaft (126) is adapted to be driven or rotated based on a rotational output provided by the output end of the first actuator (122). Further, the driven shaft (128) is operatively coupled to the drive shaft (128) by way of spur gears (142) mounted on each of the drive shaft (126) and the driven shaft (128). During an operation of the hematology analyzer (100), the first actuator (122) drives or rotates the drive shaft (126), which in turn transfers the rotational motion to the driven shaft (128) via the spur gears (142). Further, the pair of rollers (130) of the first transmission unit (120) comprises a first roller (132) and a second roller (134) provided at an end of the frame body (102) that is opposite to the pair of shafts (124) of the first transmission unit (120). As shown in FIG. 2, the first roller (132) and the second roller (134) are disposed opposite to the drive shaft (126) and the driven shaft (128), respectively.

The pair of rollers (130) and the pair of shafts (124) are operatively coupled to each other by the pair of conveyor belts (136). The pair of conveyor belts (136) comprises a first conveyor belt (138) and a second conveyor belt (140). As shown in FIG. 2, the first conveyer belt (138) is adapted to extend between the drive shaft (126) and the first roller (132). Further, the second conveyer belt (140) is adapted to extend between the driven shaft (128) and the second roller (134). Each of the first roller (132) and the second roller (134), and thus the first conveyer belt (138) and the second conveyer belt (140), are adapted to be driven, i.e., rotated, by the first actuator (122) of the first transmission unit (120). In accordance with the present disclosure, each of the first conveyer belt (138) and the second conveyer belt (140) is adapted to be driven and/or rotated by the first actuator (122) along with the first axis (X-X′) of the frame body (102) of the hematology analyzer (100).

With reference to FIG. 2, each of the first conveyer belt (138) and the second conveyer belt (140) comprises a plurality of segments (144) for holding the cartridge unit (200). The plurality of segments (144) may be integrally formed or fixed on each of the first conveyor belt (138) and the second conveyor belt (140). The plurality of segments (144) formed on one conveyor belt may extend towards the other conveyor belt. In accordance with the present disclosure, the plurality of segments (144) is adapted to hold the cartridge unit (200) therebetween. When the cartridge unit (200) is being held by the plurality of segments (144), the first transmission unit (120) may move the cartridge unit (200) along the first axis (X-X′) of the frame body (102) of the hematology analyzer (100).

Referring again to FIGS. 2 to 4, the hematology analyzer (100) comprises a second transmission unit (150) and a fluid analysis module (170). The second transmission unit (150) is provided on the platform (104) of the body frame (102) of the hematology analyzer (100). In accordance with the present disclosure, the fluid analysis module (170) of the hematology analyzer (100) is disposed on the second transmission unit (150). The fluid analysis module (170) is adapted to move along the second axis (Y-Y′) of the frame body (102) by the second transmission unit (150). As shown in FIGS. 2 to 4, the fluid analysis module (170) is coupled to the second transmission unit (150) and is supported by a pair of supporting bars (118), such that, upon actuation by the second transmission unit (150), the fluid analysis module (170) is adapted to slide relative to the supporting bars (118), and thus move along the second axis (Y-Y′) of the frame body (102). A sliding movement of the fluid analysis module (170), along the second axis (Y-Y′) of the frame body (102) is facilitated by block and bearings arrangement (not shown) that is adapted to support the fluid analysis module (170) on the pair of supporting bars (118).

With reference to FIGS. 2 to 4, the second transmission unit (150) comprises a second actuator (152), and a lead screw (154). In an embodiment of the present disclosure, the second actuator (152) of the second transmission unit (150) is operatively coupled to the electronic power supply system (112) provided on the hematology analyzer (100) in order to draw energy for operations thereof. In a non-limiting embodiment of the present disclosure, the second actuator (152) is a stepper motor (152). The second actuator (152) is adapted to operate the one or more components of the second transmission unit (150). Further, the lead screw (154) may be coupled to an output shaft of the second actuator (152). The lead screw (154) may be adapted to be rotated with the output shaft of the second actuator (152). During an operation of the hematology analyzer (100), the second actuator (152) drives or rotates the lead screw (154) in clockwise or counter-clockwise directions.

In accordance with the present disclosure, in an exemplary embodiment, the fluid analysis module (170) is disposed on the lead screw (154) of the second transmission unit (150) via a coupling member (158) such that internal threads (not visible) defined on the coupling member (158) engages with external threads (156) of the lead screw (154). Upon rotation of the lead screw (154) by the second actuator (152), the coupling member (158) engages with the lead screw (154), which leads to a movement of the fluid analysis module (170) along with the second axis (Y-Y′) of the frame body (102) of the hematology analyzer (100).

Still referring to FIGS. 2 to 4, the fluid analysis module (170) comprises a first probe (172) and a second probe (182). The first probe (172) and the second probe (182) facilitate in carrying out the analysis of the fluid sample, for example, the blood sample. In accordance with a non-limiting embodiment of the present disclosure, the fluid analysis module (170) is configured to count red blood cells (RBCs), white blood cells (WBCs), haemoglobin, and platelet counts in the fluid sample. In an embodiment of the present disclosure, the fluid analysis module (170) is configured to count red blood cells (RBCs), white blood cells (WBCs), haemoglobin, and platelet counts in the fluid sample using Coulter count principle. Each of the first probe (172) and the second probe (182) comprises a piercing element (not shown) at an end thereof. The piercing element is adapted to pierce the elastomeric seal (210) of the compartments (202, 204, 206, 208) of the cartridge unit (200) such that the fluids from the compartments (202, 204, 206, 208) of the cartridge unit (200) may be received in the fluid analysis module (170). In an embodiment, the first probe (172) of the fluid analysis module (170) is configured to pierce the elastomeric seal (210) of the first compartment (202) and the third compartment (206) to receive the red blood cells sample and the white blood cells sample. Further, the second probe (182) is configured to pierce the second compartment (204) and the fourth compartment (208) of the cartridge unit (200) to receive the cleaning fluid. The cleaning fluid is utilized to clean the first probe (172) and the second probe (182) of the fluid analysis module (170).

In accordance with the present disclosure, the second probe (182) comprises a three-way valve. The three-way valve may be provided in a base unit (184) of the second probe (182) of the fluid analysis module (170). The three-way valve may be adapted to fluidly couple the second probe (182) with the first probe (172) of the fluid analysis module (170) such that the cleaning fluid received in the second probe (182) may be supplied to the first probe (172) to clean the first probe (172) internally and externally. Without limiting the scope of protection of the present disclosure, in an embodiment, a first output port of the three-way valve may be coupled to an inlet port (176) of a headrinse unit (174) that is configured to supply the cleaning fluid to an external surface of the first probe (172) to cleanse the first probe (172) externally. In an embodiment, the headrinse unit (174) is utilized for additional cleaning of the first probe (172) by directing the cleaning fluid to the headrinse unit (174). As the cleaning fluid enters the headrinse unit (174), a centrifugal action due to a structure of the headrinse unit (174) is generated and said centrifugal action effectively cleans the external surface of the first probe (172). Cleaning the external surface of the first probe (172) is crucial, as the first probe (172) accesses various compartments of the cartridge unit (200). Failure to clean the first probe (172) may result in sample contamination, and thus errors in the results. Further, a second output port of the three-way valve may be coupled to a side inlet port (178) of the first probe (172) that is configured to supply the cleaning fluid to an internal surface of the first probe (172) to cleanse the first probe (172) internally.

During an operation of the hematology analyzer (100) of the present disclosure, the cartridge unit (200) containing the fluid sample to be analyzed is held in the first transmission unit (120). Particularly, the cartridge unit (200) is held between the first conveyor belt (138) and the second conveyor belt (140), by way of the plurality of segments (144). Further, upon a movement of the first transmission unit (120), the first transmission unit (120) is configured to move the cartridge unit (200) along the first axis (X-X′) of the frame body (102) to align the first compartment (202) and the second compartment (204) with the first probe (172) and the second probe (182), respectively. Referring to FIG. 3, the first transmission unit (120) is configured to move the cartridge unit (200) along the first axis (X-X′) of the frame body (102) such that the first compartment (202) containing the red blood cells sample (to be analyzed) and the second compartment (204) containing the cleaning fluid is aligned with the first probe (172) and the second probe (182), respectively.

Once the first compartment (202) and the second compartment (204) are aligned with the first probe (172) and the second probe (182), respectively, the second transmission unit (150) is configured to move the fluid analysis module (170) along the second axis (Y-Y′) of the frame body (102) such that the first probe (172) pierces the first compartment (202) and the second probe (182) pierces the second compartment (204). In accordance with the present disclosure, and referring to FIG. 3, the first probe (172) pierces the first compartment (202) to receive the red blood cells sample, for example to determine a count of the red blood cells in the blood sample. Further, the second probe (182) pierces the second compartment (204) to receive the cleaning fluid in order to supply the cleaning fluid to the first probe (172) in order to clean the first probe (172) externally and internally as explained above.

Similarly, referring to FIG. 4, the first transmission unit (120) is configured to move the cartridge unit (200) along the first axis (X-X′) of the frame body (102) to align the third compartment (206) and the fourth compartment (208) with the first probe (172) and the second probe (182), respectively, such that the third compartment (206) containing the white blood cells sample (to be analyzed) and the fourth compartment (208) containing the cleaning fluid is aligned with the first probe (172) and the second probe (182), respectively.

Once the third compartment (206) and the fourth compartment (208) are aligned with the first probe (172) and the second probe (182), respectively, the second transmission unit (150) is configured to move the fluid analysis module (170) along the second axis (Y-Y′) of the frame body (102) such that the first probe (172) pierces the third compartment (206) and the second probe (182) pierces the fourth compartment (208). In accordance with the present disclosure, and referring to FIG. 4, the first probe (172) pierces the third compartment (206) to receive the white blood cells sample, for example to determine a count of the white blood cells in the blood sample. Further, the second probe (182) pierces the fourth compartment (208) to receive the cleaning fluid in order to supply the cleaning fluid to the first probe (172) in order to clean the first probe (172) externally and internally as explained above.

Upon completion of the analysis of the fluid sample contained in the cartridge unit (200), the entire cartridge unit (200) is taken out from the hematology analyzer (100) and then discarded. In an embodiment of the present disclosure, the hematology analyzer (100) may comprise one or more vacuum syringes that may be adapted to generate negative and positive pressure within the hematology analyzer (100) for specific sequences. The vacuum syringe may be configured to collect reagents (i.e., the red blood cells sample, the white blood cells sample and the cleaning fluids) after analysis/counting from the counting unit and then send this waste fluid to a waste container (that may be provided in the hematology analyzer (100)). Additionally, the hematology analyzer (100) may comprise solenoid valve control units, which, when electrically energized or de-energized, either shut off or allow the fluid flow. The solenoid valve control unit may take the form of an electromagnet. When energized, a magnetic field builds up which pulls a plunger or pivoted armature against the action of a spring.

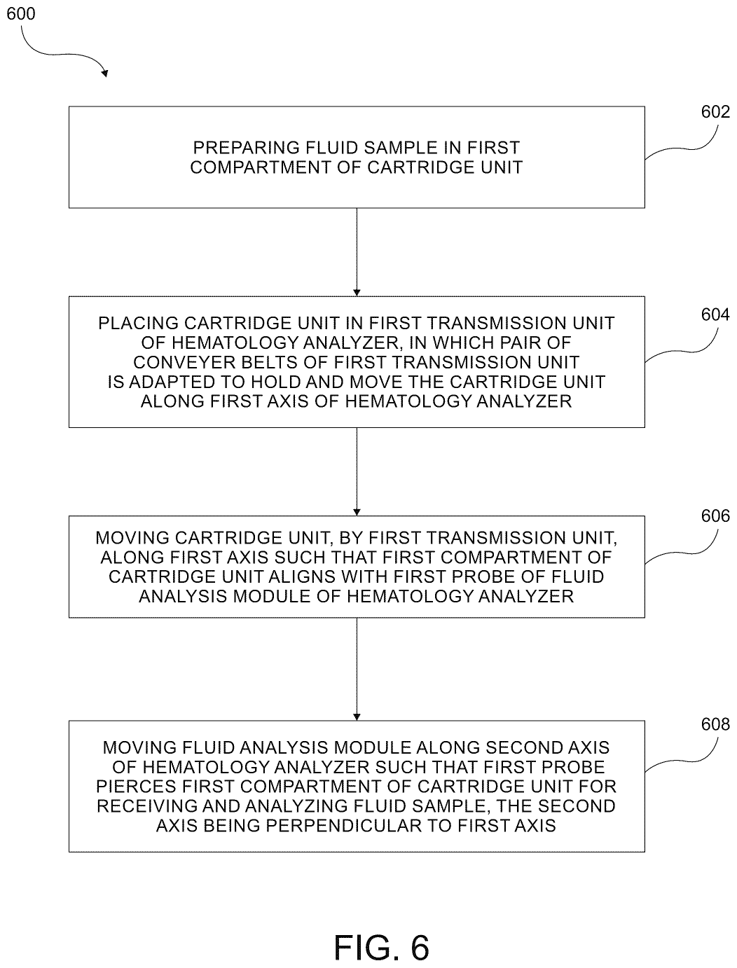

Referring to FIG. 6, a method (600) for analyzing a fluid sample is illustrated. The method (600) for analyzing the fluid sample may be performed by the hematology analyzer (100) of the present disclosure. In accordance with the present disclosure, in an embodiment, the method (600), at step (602) comprises preparing the fluid sample in a first compartment (202, 206) of the cartridge unit (200). As discussed above, in an embodiment, as shown in FIG. 5, the cartridge unit (200) may comprise four compartments, namely the first compartment (202), the second compartment (204), the third compartment (206) and the fourth compartment (208). The first compartment (202) may contain the red blood cells sample to be analyzed, the third compartment (206) may contain the white blood cells sample to be analyzed, and the second and fourth compartments (204, 208) may contain the cleaning fluid.

In an embodiment, preparing the fluid sample comprises mixing the fluid sample with one or more reagents. The one or more reagents comprises hematology diluent or LYSE. In accordance with the present disclosure, preparing the red blood cells sample in the first compartment (202) of the cartridge unit (200) comprises mixing the blood sample with hematology diluent. Further, preparing the white blood cells sample in the third compartment (206) of the cartridge unit (200) comprises mixing the blood sample with LYSE. Furthermore, in an embodiment, mixing the fluid sample with the one or more reagents is performed outside the hematology analyzer (100).

The method (600), at step (604), further comprises placing the cartridge unit (200) in the first transmission unit (120) of the hematology analyzer (100). In an embodiment, placing the cartridge unit (200) in the hematology analyzer (100) comprises placing the cartridge unit (200) between the pair of conveyer belts (136) of the first transmission unit (120) such that the pair of conveyor belts (136) is adapted to hold and move the cartridge unit (200) along the first axis (X-X′) of the hematology analyzer (100). The method (600), at step (606), furthermore comprises moving the cartridge unit (200), by the first transmission unit (120), along the first axis (X-X′) such that the first compartment (202, 206) of the cartridge unit (200) aligns with the first probe (172) of the fluid analysis module (170) of the hematology analyzer (100).

Further, the method (600), at step (608), comprises moving the fluid analysis module (170) along the second axis (Y-Y′) of the hematology analyzer (100) such that the first probe (172) pierces the first compartment (202, 206) of the cartridge unit (200) for receiving and analyzing the fluid sample. Referring again to FIG. 3, according to the method (600), the first transmission unit (120) moves the cartridge unit (200) along the first axis (X-X′) to align the first compartment (202) containing the red blood cells sample (to be analyzed) with the first probe (172). Subsequently, the second transmission unit (150) moves the fluid analysis module (170) along the second axis (Y-Y′) such that the first probe (172) pierces the first compartment (202) to receive the red blood cells sample, for example to determine a count of the red blood cells in the blood sample.

Similarly, referring to FIG. 4, according to the method (600), the first transmission unit (120) moves the cartridge unit (200) along the first axis (X-X′) to align the third compartment (206) containing the white blood cells sample (to be analyzed) with the first probe (172). Subsequently, the second transmission unit (150) moves the fluid analysis module (170) along the second axis (Y-Y′) such that the first probe (172) pierces the third compartment (206) to receive the white blood cells sample, for example to determine a count of the white blood cells in the blood sample.

In an embodiment of the present disclosure, the method (600) comprises placing the cleaning fluid in the second compartment (204) (or the fourth compartment (208)) of the cartridge unit (200). The method (600) further comprises moving the cartridge unit (200), by the first transmission unit (120), along the first axis (X-X′) such that the second compartment (204) (or the fourth compartment (208)) aligns with the second probe (182) of the fluid analysis module (170) while the first compartment (202) (or the third compartment (206)) is aligned with the first probe (172). The method (600) furthermore comprises moving the fluid analysis module (170) along the second axis (Y-Y′) of the hematology analyzer (100) such that the second probe (182) pierces the second compartment (204) (or the fourth compartment (208)) for receiving the cleaning fluid to clean the first probe (172) of the fluid analysis module (170). In accordance with the present disclosure, the second probe (182) pierces the second compartment (204) (or the fourth compartment (208)) to receive the cleaning fluid in order to supply the cleaning fluid to the first probe (172) in order to clean the first probe (172) externally and internally as explained above.

Within the scope of the present disclosure, the hematology analyzer (100) and the method (600) for analyzing the fluid sample require a single-usage cartridge unit (200) for complete blood count (CBC) analyzer device. The design of the hematology analyzer (100) of the present disclosure enhances analyzer device compactness and ease of handling, requires a minimal number of modules, and reduces the cost for each test performed.

The various embodiments of the present disclosure have been described above with reference to the accompanying drawings. The present disclosure is not limited to the illustrated embodiments; rather, these embodiments are intended to fully and completely disclose the subject matter of the disclosure to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for case of description to describe one element or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Herein, the terms “attached”, “connected”, “interconnected”, “contacting”, “mounted”, “coupled” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

REFERENCE NUMERALS

| PARTICULARS | REFERRAL NUMERAL |
|---|---|
| Hematology Analyzer | 100 |
| Frame Body | 102 |
| Platform | 104 |
| Panels | 106 |
| Window | 108 |
| Dispaly Unit | 110 |
| Electronic Power Supply System | 112 |
| Pair of Rails | 114 |
| First Rail | 114′ |
| Columns | 116 |
| Pair of Supporting Bars | 118 |
| First Transmission Unit | 120 |
| First Actuator | 122 |
| Pair of Shafts | 124 |
| Drive Shaft | 126 |
| Driven Shaft | 128 |
| Pair of Rollers | 130 |
| First Roller | 132 |
| Second Roller | 134 |
| Pair of Conveyor Belts | 136 |
| First Conveyor Belt | 138 |
| Second Conveyor Belt | 140 |
| Spur Gears | 142 |
| Segments | 144 |
| Second Transmission Unit | 150 |
| Second Actuator | 152 |
| Lead Screw | 154 |
| External Threads | 156 |
| Coupling Member | 158 |
| Fluid Analysis Module | 170 |
| First Probe | 172 |
| Headrinse Unit | 174 |
| Inlet Port | 176 |
| Side Inlet Port | 178 |
| Second Probe | 182 |
| Base Unit | 184 |
| Cartridge Unit | 200 |
| First Compartment | 202 |
| Second Compartment | 204 |
| Third Compartment | 206 |
| Fourth Compartment | 208 |
| Elastomeric Seal | 210 |
| Method | 600 |
| Step | 602 |
| Step | 604 |
| Step | 606 |
| Step | 608 |
| First Axis | X-X′ |
| Second Axis | Y-Y′ |

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

What is claimed is:

1. A hematology analyzer for analyzing a fluid sample, comprising:
a frame body having
a platform;
a pair of rails arranged above the platform and supported by one or more columns; and
the frame body defines a first axis (X-X′) along the pair of rails and a second axis (Y-Y′) that is perpendicular to the first axis (X-X′) and the platform;
a cartridge unit comprising at least two compartments, in which a first compartment of the at least two compartments contains the fluid sample to the analyzed and a second compartment of the at least two compartments contains a cleaning fluid;
a first transmission unit provided on the pair of rails and configured to:
hold the cartridge unit; and
move the cartridge unit along the first axis (X-X′) of the frame body;
a second transmission unit provided on the platform; and
a fluid analysis module disposed on the second transmission unit and adapted to move along the second axis (Y-Y′) of the frame body by the second transmission unit, the fluid analysis module comprising a first probe and a second probe,
wherein,
the first transmission unit is configured to move the cartridge unit along the first axis (X-X′) of the frame body to align the first compartment and the second compartment with the first probe and the second probe, respectively, and
the second transmission unit is configured to move the fluid analysis module along the second axis (Y-Y′) of the frame body such that the first probe pierces the first compartment and the second probe pierces the second compartment.

2. The hematology analyzer of claim 1, wherein the cartridge unit comprises four compartments, in which
the first compartment contains a red blood cells sample to be analyzed;
the second compartment contains the cleaning fluid;
a third compartment contains a white blood cells sample to be analyzed; and
a fourth compartment contains the cleaning fluid.

3. The hematology analyzer of claim 1, wherein each compartment of the at least two compartments comprises an elastomeric seal which is adapted to be pierced by the respective probe of the fluid analysis module.

4. The hematology analyzer of claim 2, wherein each of the red blood cells sample and the white blood cells sample is prepared by mixing the fluid sample with one or more reagents,
the one or more reagents mixed with the fluid sample to form the red blood cells sample comprises hematology diluent, and
the one or more reagents mixed with the fluid sample to form the white blood cells sample comprises LYSE.

5. The hematology analyzer of claim 1, wherein the cleaning fluid cleans the first probe of the fluid analysis module and comprises RINSE.

6. The hematology analyzer of claim 2, wherein
the red blood cells sample and the white blood cells sample are prepared in the cartridge unit outside the hematology analyzer, and
the cartridge unit is a disposable cartridge unit.

7. The hematology analyzer of claim 1, wherein the fluid analysis module is configured to count red blood cells (RBCs), white blood cells (WBCs), hemoglobin, and platelet counts.

8. The hematology analyzer of claim 2, wherein the second probe comprises a three-way valve adapted to supply the cleaning fluid to the first probe to clean the first probe internally and externally.

9. The hematology analyzer of claim 1, wherein the first transmission unit comprises:
a first actuator;
a drive shaft and a driven shaft adapted to be driven by the first actuator;
a first roller and a second roller disposed opposite to the drive shaft and the driven shaft, respectively; and
a first conveyer belt extending between the drive shaft and the first roller and a second conveyer belt extending between the driven shaft and the second roller,
each of the first conveyer belt and the second conveyer belt is adapted to be driven by the first actuator such that the cartridge unit held by the first transmission unit is movable along with the first axis (X-X′) of the frame body.

10. The hematology analyzer of claim 9, wherein each of the first conveyer belt and the second conveyer belt comprises a plurality of segments for holding the cartridge unit.

11. The hematology analyzer of claim 1, wherein the second transmission unit comprises;
a second actuator; and
a lead screw coupled to an output shaft of the second actuator and adapted to be rotated with the output shaft of the second actuator,
wherein the fluid analysis module is disposed on the lead screw and is moved along with the second axis (Y-Y′) of the frame body, upon a rotation of the lead screw.

12. A method for analyzing a fluid sample, the method comprising:
preparing the fluid sample in a first compartment of a cartridge unit;
placing the cartridge unit in a first transmission unit of a hematology analyzer, in which a pair of conveyer belts of the first transmission unit is adapted to hold and move the cartridge unit along a first axis (X-X′) of the hematology analyzer;
moving the cartridge unit, by the first transmission unit, along the first axis (X-X′) such that the first compartment of the cartridge unitaligns with a first probe of a fluid analysis module of the hematology analyzer; and
moving the fluid analysis module along a second axis (Y-Y′) of the hematology analyzer such that the first probe pierces the first compartment of the cartridge unit for receiving and analyzing the fluid sample, the second axis (Y-Y′) being perpendicular to the first axis (X-X′).

13. The method of claim 12, wherein
preparing the fluid sample in the first compartment of the cartridge unit comprises mixing the fluid sample with one or more reagents, the one or more reagents comprising hematology diluent or LYSE, and
mixing the fluid sample with the one or more reagents is performed outside the hematology analyzer.

14. The method of claim 12, wherein the method comprises:
placing a cleaning fluid in a second compartment of the cartridge unit;
moving the cartridge unit, by the first transmission unit, along the first axis (X-X′) such that the second compartment aligns with a second probe of the fluid analysis module while the first compartment is aligned with the first probe; and
moving the fluid analysis module along the second axis (Y-Y′) of the hematology analyzer such that the second probe pierces the second compartment for receiving the cleaning fluid to clean the first probe of the fluid analysis module.
